(19) United States
(12) Patent Application Publication
(10) Pub. No.: US 2015/0113755 A1
(43) Pub. Date: Apr. 30, 2015

(54) LONGITUDINAL BODY FOR A VEHICLE WINDOW WIPER

(71) Applicant: Valeo Systèmes d'Essuyage, Le Mesnil Saint Denis (FR)

(72) Inventor: Lionel Cros, La Roche Blanche (FR)

(21) Appl. No.: 14/527,940

(22) Filed: Oct. 30, 2014

(30) Foreign Application Priority Data
Oct. 30, 2013 (FR) 1360646

(51) Int. Cl. B60S 1/38

(52) U.S. Cl. CPC B60S 1/38; B60S 1/3808; B60S 1/3875; B60S 2001/382
USPC 15/250.201; 15/250.38

(57) ABSTRACT

A longitudinal body for a wiper for a window of a vehicle, in particular a motor vehicle, is disclosed. The longitudinal body is formed in one piece and is configured to hold a wiper blade and/or retaining a stiffener vertebra by at least one housing for receiving the vertebra or a heel of the wiper blade. The longitudinal body defines at least one internal longitudinal cavity that extends out of the housing, the cavity being intersected by a longitudinal plane P passing through vertical walls delimiting the housing.

### TECHNICAL FIELD

The present invention concerns a longitudinal body for a window wiper for a vehicle, in particular a motor vehicle, and a wiper including such a body.

### PRIOR ART

A wiper for a window such as the windscreen of a motor vehicle typically includes a longitudinal body and means for retaining a wiper blade, generally made of rubber, intended to rub against the window of the vehicle to evacuate water and remove it from the field of view of the driver. The wiper further includes means for retaining a longitudinal vertebra that stiffens the wiper blade, so as to favour the application of this blade to the windscreen. The wiper is carried by an arm that is driven with an angular to-and-fro movement by a motor. The means connecting the wiper to the arm generally include a connector that is fastened to the body and an adapter that is articulated to the body and fixed to one end of the arm.

To simplify the manufacture of the wiper, it has already been proposed to form in one piece the body, the means for holding the wiper blade and the means for retaining the stiffener vertebra.

However, the major disadvantage of prior art wipers of this type is that their body is not sufficiently flexible, which reduces the effectiveness of wiping the windscreen. This problem is aggravated in winter because low temperatures limit the flexibility of these wipers.

The invention proposes a simple, effective and economical solution to this problem.

### SUMMARY OF THE INVENTION

The invention proposes a longitudinal body for a wiper for a window of a vehicle, in particular a motor vehicle, said longitudinal body being formed in one piece with means for holding a wiper blade and/or means for retaining a stiffener vertebra, said means defining at least one housing receiving the vertebra or a heel of the wiper blade, said housing being delimited at least in part by a horizontal wall and two vertical walls, said vertical walls being respectively shorter than said horizontal wall seen in cross section, characterized in that said body defines at least one internal longitudinal cavity that extends out of said housing, said cavity being intersected by a longitudinal plane P, P′ passing through said vertical walls.

In the present application, there is meant by an internal cavity a cavity that is located inside the body of the wiper. Said means comprise first means for holding a wiper blade and/or second means for retaining a stiffener vertebra. These means define at least one housing delimited at least in part by a horizontal wall and two vertical walls, the latter optionally being substantially perpendicular to or inclined relative to the horizontal wall. The holding and/or retaining means may for example consist in gluing the wiper blade and/or the stiffener vertebra to one or more of said horizontal and vertical walls. It is more preferable if the means for holding the wiper blade and/or retaining the stiffener vertebra respectively comprise longitudinal hooks for holding the blade and/or retaining the vertebra, these hooks defining with said horizontal wall and said vertical walls said housing receiving the vertebra and/or a heel of the wiper blade.

The presence of the internal cavity or cavities makes it possible to reduce the stiffness of the body and therefore to make it more flexible, which makes it possible to improve the efficacy of wiping, even in winter. In accordance with the invention, these cavities are intersected by the longitudinal plane P, P′ passing through the vertical walls delimiting the housing receiving the vertebra or the heel of the blade. They are therefore substantially located at the sides of the body, which may result in an increase in the width of the body relative to those of prior art wipers.

In the prior art, the stiffener vertebra may be mounted with lateral clearances in the body of the wiper that define longitudinal spaces. These spaces do not define cavities in the sense of the invention because they are not located outside the housing receiving the vertebra. They are not designed to optimize the flexibility of the body but merely to facilitate mounting the vertebra by sliding it into its housing.

In accordance with one preferred embodiment of the invention, said at least one longitudinal cavity lies on either side of said means for holding a wiper blade and/or retaining a stiffener vertebra.

The aforementioned holding and retaining means may define a first housing receiving the vertebra and a second housing receiving the heel of the blade, said at least one cavity extending over at least all the height of one of said housings and optionally over at least part of the height of the other of said housings. The height of each housing is measured in a direction substantially perpendicular to the plane P, P′. The flexibility of the body may notably be a function of this height.

The cavity or each cavity may have in cross section a base or lower end wider than its top or upper end.

The holding and/or retaining means of the body may include at least two longitudinal hooks. Said at least one cavity preferably extends at least in part between one of these hooks and a lateral wall of the body. Each lateral wall may be substantially U-, C- or V-shaped in cross section, the open side of which shape is oriented toward an opposite lateral wall of the body.

The body of the wiper advantageously has a longitudinal plane U of symmetry substantially perpendicular to the plane P, P′.

The wall or part of the exterior periphery of the body that borders said at least one cavity may form an aerodynamic deflector. The aerodynamic deflector is advantageously made from an elastomer-based material the Shore A hardness of which is between 70 and 83.

The body of the wiper may be made from one or two materials, notably elastomer-based materials, for example by extrusion or co-extrusion. A two-material body can make it possible to facilitate optimizing its flexibility. For example, the body of the wiper may include an upper part that is more flexible or softer than its lower part. The upper part is preferably sufficiently rigid to facilitate cutting it to form a housing receiving the connector of the wiper, avoiding the risk of the body collapsing when this cut is made.

In one embodiment, the housing receiving the vertebra communicates with said at least one cavity.

Alternatively, said at least one cavity is isolated from said housing receiving the vertebra and configured to be supplied with windscreen-washing liquid. By isolation of the cavity or cavities is meant that the cavity or cavities does/do not communicate with the housing receiving the vertebra defined by the retaining means. The cavity or cavities thus form(s) means for circulation of windscreen-washing liquid that are accommodated in the body of the wiper and not attached to the latter, which simplifies the body and avoids widening it further.

In this latter case, the body of the wiper may include, for example at the level of its lateral walls, windscreen-washing liquid spray orifices that lead into said at least one cavity.

The aforementioned means may include hooks for retaining the vertebra, at least one hook for retaining the vertebra, and preferably each hook for retaining the vertebra, being connected to an upper wall or a lateral wall of the body by at least one longitudinal web for isolating said at least one cavity. This web may be produced when manufacturing the body, for example by extrusion or co-extrusion.

The body of the wiper may have in cross section a shape comprising two parts, respectively an upper part and a lower part, the upper part being substantially triangular and the lower part being substantially trapezoidal or hexagonal. Said upper part is preferably more flexible or softer than said lower part.

The invention further concerns a longitudinal body as described above in which said at least one longitudinal cavity has a contour of substantially identical shape in cross section to the exterior periphery of the body.

The present invention also concerns a vehicle window wiper including a longitudinal body as described above, a wiper blade and a stiffener vertebra, said blade or said vertebra being received in said housing.

The wiper may comprise a single longitudinal body, wherein for example at least one cut-out is formed to serve as a housing for the connector.

In an alternative embodiment of the longitudinal body is made of several separate portions, for example between two and ten portions, which are arranged longitudinally one next to the other, in particular connected to one another by intermediate connectors comprising fastening means.

The longitudinal body, or each independent portion, presents for example a length greater than 100 mm.

The present invention finally concerns a vehicle window wiping system for a vehicle, in particular a motor vehicle, including at least one wiper as described above.

### DESCRIPTION OF THE FIGURES

The invention will be better understood and other details, features and advantages of the invention will become apparent on reading the following description given by way of nonlimiting example and with reference to the appended drawings, in which:

FIG. 1 is an exploded perspective view of a prior art wiper system,

FIG. 2 is a diagrammatic view in cross section of a wiper longitudinal body in accordance with the invention, and

FIGS. 3 to 7 are diagrammatic views in cross section of wiper longitudinal bodies of variant embodiments of the invention.

### DETAILED DESCRIPTION

It should be noted that the figures show the invention in detail for the purposes of implementing the invention, said figures of course also defining the invention more clearly where necessary.

In the following description, references to longitudinal or lateral refer to the orientation of the wiper in accordance with the invention. The longitudinal direction corresponds to the main axis of the wiper along which it extends and the lateral orientations correspond to straight line segments that are concurrent, i.e. that cross the longitudinal direction, notably perpendicular to the longitudinal axis of the wiper in its plane of rotation. For the longitudinal directions, the terms exterior and interior are relative to the point at which the wiper is fixed to a wiper arm, the term interior corresponding to the part in which the arm and one half of the wiper extend. Finally, the directions referred to as upper and lower correspond to orientations perpendicular to the plane of rotation of the wiper, the term lower embracing the plane of the windscreen.

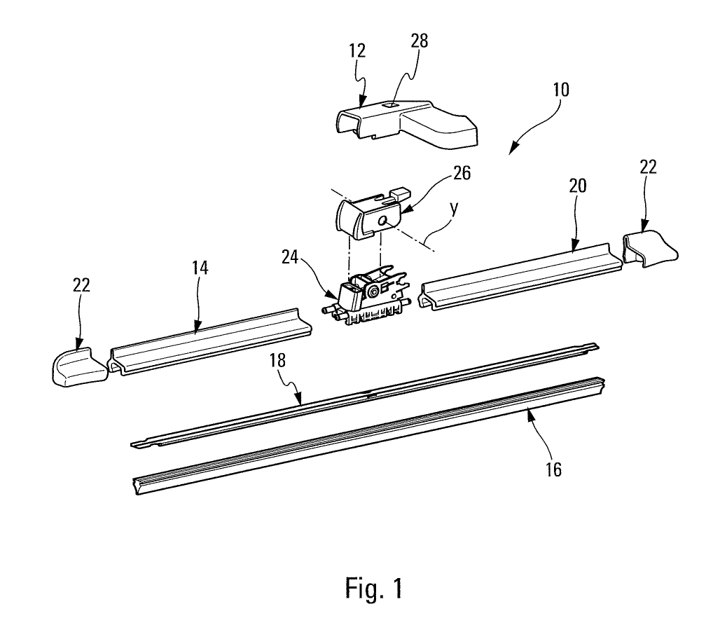

There is shown in FIG. 1 a prior art system for wiping a windscreen of a vehicle, in particular a motor vehicle. This system includes a windscreen wiper 10 and a wiper arm 12 that is partially represented and intended to be driven by a motor to execute an angular to-and-fro movement for evacuating water and possibly other unwanted elements covering the windscreen.

Here the wiper 10 includes a longitudinal body 14, a wiper blade 16, generally made of rubber, and at least one vertebra 18 that stiffens the blade 16 and favours its application to the windscreen.

The body 14 of the wiper 10 includes an upper aerodynamic deflector 20 intended to improve the operation of the wiper system, the object of this deflector 20 being to press the wiper more firmly onto the windscreen and thus to enhance the aerodynamic performance of the system.

The wiper 10 further includes end-pieces or clips 22 for attaching the blade 16 and the vertebra 18 to the body, these clips 22 being located at each of the longitudinal ends of the body 14.

Here the body 14 of the wiper is made in two independent parts that are disposed substantially end-to-end and connected to each other by an intermediate connector 24. This connector 24 is therefore inserted between the two parts of the body 14 and includes means for fixing it to these parts. The invention must be understood as also concerning a windscreen wiper including a single body 14 in which there is made a cut-out intended to serve as a housing for an intermediate connector 24 (this variant is not shown).

For mounting it on the arm 12, the wiper 10 includes an adapter 26 mounted on the connector 24 and enabling articulation of the wiper 10 relative to the arm 12. The articulation of the wiper 10 relative to the arm 12 allows movement in rotation about a rotation axis Y perpendicular to the longitudinal axis of the wiper 10. The wiper 10 must in fact have at least one degree of freedom in rotation relative to the arm 12, and more specifically relative to an end part 28 of the arm 12, to enable the wiper 10 to follow the curvature of the windscreen.

The invention concerns a particular type of wiper in which the body 14 is made in one piece with means for retaining the vertebra 18 and/or means for holding the wiper blade 16.

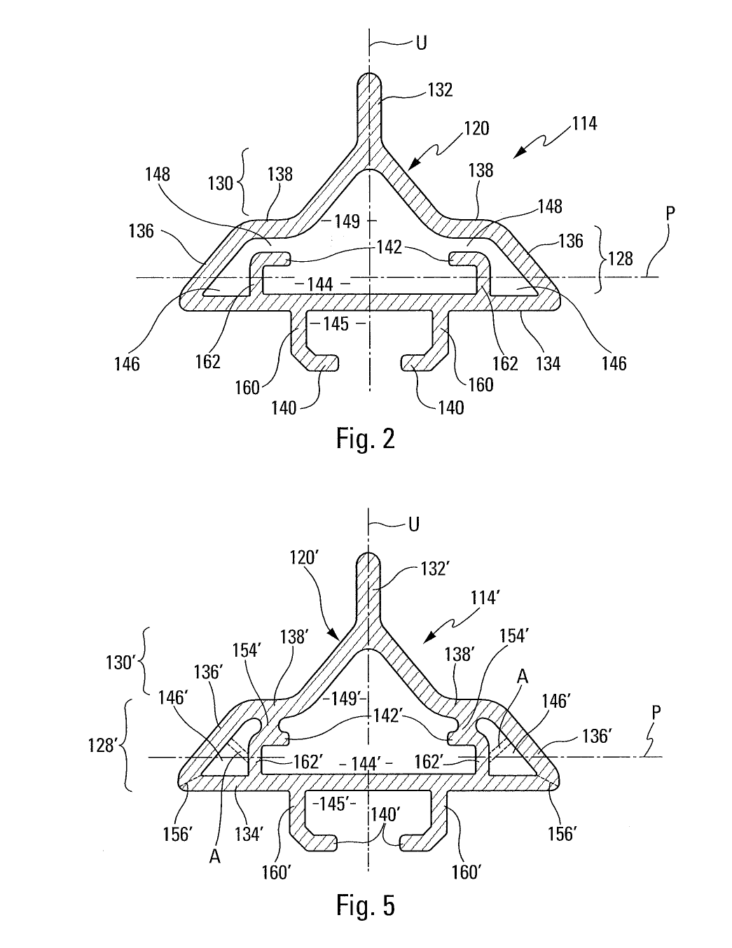

FIGS. 2 to 7 represent variant embodiments of a wiper longitudinal body in accordance with the invention, this body being formed here in one piece with means for holding a wiper blade, means for retaining a stiffener vertebra and an aerodynamic deflector.

The elements already described above are designated hereinafter by the same reference numbers increased by at least one hundred. Thus in FIG. 2 the references 114 and 120 respectively designate the body and the deflector of the wiper in accordance with the invention.

In the FIG. 2 embodiment, the body 114 is made in one piece and of a single material, for example by extrusion.

The body 114 has in section a shape having substantially two parts, respectively a lower part 128 and an upper part 130. The upper part 130 includes the deflector 120. Here this deflector 120 has in section a triangular or dihedron shape the summit or upper end of which is connected to a substantially vertical longitudinal rib 132. This dihedron comprises two inclined lateral walls, respectively a front wall and a rear wall, forming an angle between 10° and 120°, preferably between 20° and 100°, more preferably between 40° and 100°, even more preferably between 60° and 100°. The angle represented here is substantially between 80° and 90°.

The lower part 128 of the body has a trapezoidal general shape the longer base of which forms the lower end and the shorter base of which is located on the same side as the upper part 130. This lower part 128 includes a substantially plane lower horizontal wall 134 that defines the aforementioned longer base and that is connected by respective longitudinal lateral edges to the longitudinal lower edges of two longitudinal lateral walls 136. These lateral walls 136 are inclined and their respective longitudinal upper edges are connected to the longitudinal lower edges of the lateral walls of the upper part 130 by two horizontal upper walls 138 that are substantially parallel to the lower wall 134.

Here the means for holding the blade include two first longitudinal lateral hooks 140 that extend downward from the lower wall 134. Each hook 140 includes a vertical wall 160 the longitudinal upper edge of which is connected to the lower wall 134 and the longitudinal lower edge of which is connected to a horizontal rim oriented toward the other hook 140. These first hooks 140 are therefore substantially parallel and each has a substantially L-shaped section. They define between them a housing 145 receiving a heel of the wiper blade.

The means for retaining the vertebra here include two second longitudinal lateral hooks 142 that extend upward from the lower wall 134.

These second hooks 142 are substantially parallel and each has a substantially L-shaped section. Here they are located under respective upper walls 138. Each hook 142 includes a vertical wall 162 the longitudinal lower edge of which is connected to the lower wall 134 and the longitudinal upper edge of which is connected to a horizontal rim oriented toward the other hook 142. A longitudinal plane P passes through the vertical walls 162, here substantially at their mid-height in cross section. Here the geometrical plane P is substantially parallel to the lower wall 134.

These hooks 142 define between them a housing 144 receiving the vertebra. As can be seen in FIG. 2, this housing 144 has in cross section an elongate shape in the longitudinal plane P.

The lateral walls 136 extend at a distance from the hooks 142 and define with the latter a longitudinal cavity 146 which therefore extends on either side of the means for retaining the vertebra and which the plane P intersects.

The upper walls 138 are at a distance from the hooks 142 and define with them longitudinal passages 148. It can be seen that the cavity portions 146 located on either side of the retaining means communicate with the housing 144 and the internal space 149 defined by the deflector 120 via these passages 148.

In FIG. 2 the body 114 has a substantially vertical longitudinal plane U of symmetry.

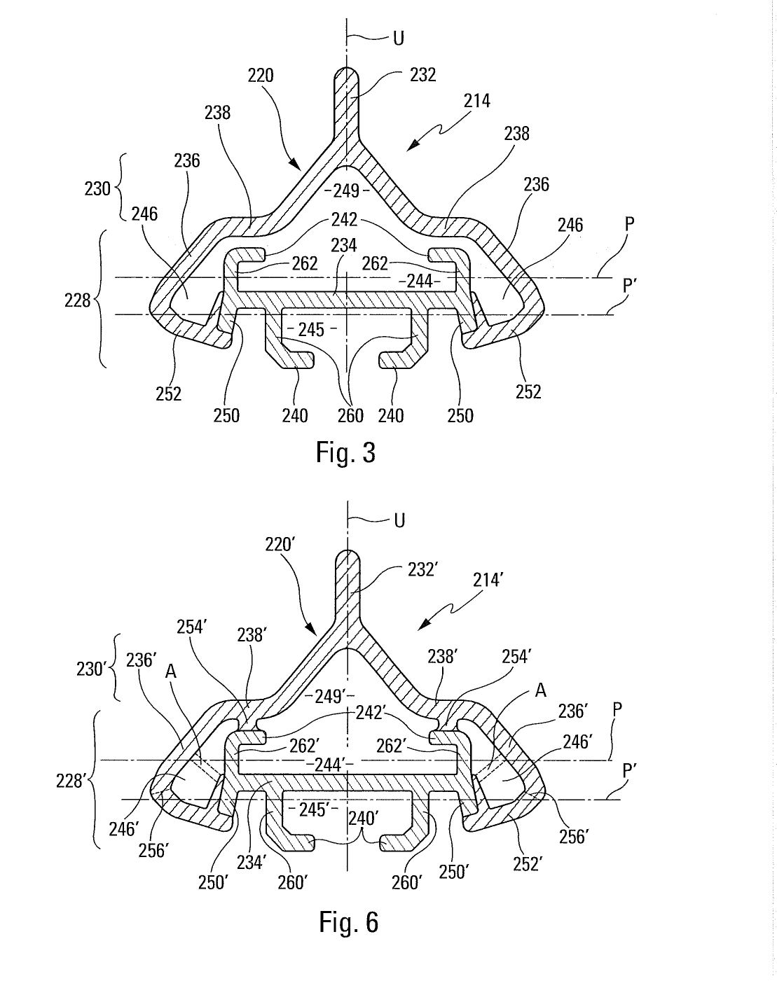

The FIG. 3 variant embodiment differs from the previous embodiment notably in that the body 214 of the wiper is formed in one piece, for example by extrusion, from two different materials, a first material for the hooks 240, 242 of the holding and retaining means and a second material for the rest of the body.

Here the lateral cavity 246 of the body 214 lies on either side of the retaining means (hooks 242) and on either side of an upper part of the holding means (hooks 240).

Here the body 214 includes a horizontal lower wall 234 the longitudinal lateral edges of which are each connected on the one hand to the longitudinal lower edge of a hook 242 and on the other hand to the longitudinal upper edge of a substantially vertical longitudinal rim 250. The hooks 240 extend downward from this lower wall 234. The lower wall 234, the hooks 240, 242 and the rims 250 are made from the first material.

The longitudinal lower edges of the lateral walls 236 of the body 214 are connected to lateral lugs 252 that extend on each side of the holding means (hooks 240). These lugs 252, the lateral walls 236 and the rest of the upper part of the body 214 are made from the first material. Here the connecting areas between the two materials are located between the lugs 252 and the rims 250.

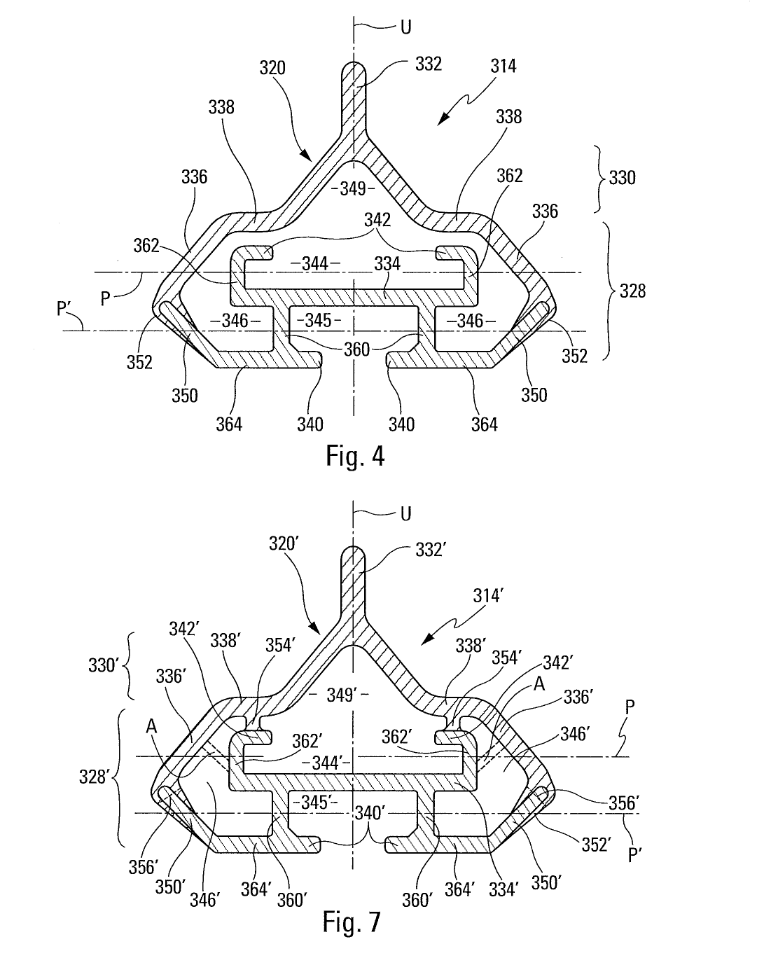

The FIG. 4 variant embodiment differs from the previous embodiment notably in the shape of the lower part of the body 314, which is substantially hexagonal here, and by the areas connecting the two materials of the body. Moreover, the lateral cavity 346 of the body 214 here lies on either side of the retaining means (hooks 342) and the holding means (hooks 340) over substantially all their height (measured in a direction perpendicular to the plane P).

Here each hook 340 is connected by its longitudinal lower edge to a horizontal lateral wall 364 that extends from the side opposite the other hook 340 and is connected at its end opposite this other hook to an upwardly inclined lateral rim 350. The lower walls 364, the hooks 340, 342 and the rims 350 are made from the first material.

The longitudinal lower edges of the lateral walls 336 of the body 314 are connected to lateral lugs 352 that extend on each side of the holding means (hooks 340). The lugs 352, the lateral walls 336 and the rest of the upper part of the body are made from the second material. Here the connecting areas between the two materials are located between the lugs 352 and the rims 350. The hexagonal shape of the lower part 328 of the body 314 notably results from the inclination of the lateral walls 336, the lugs 352 and the rims 350.

Here the cavity 346 is intersected by both the longitudinal plane P passing through the vertical walls 362 delimiting the housing 344 receiving the vertebra 18 and the longitudinal plane P′ passing through the vertical walls 360 delimiting the housing 345 receiving the heel of the blade 16.

In each of the embodiments of FIGS. 2 to 4, the body is relatively flexible because of the number and location of the areas connecting its upper and lower parts. In fact, the upper part 130, 230, 330 of the body is connected to its lower part 128, 228, 328 only by the lateral walls 136, 236, 336 of the body. Because of the flexibility of these lateral walls, the body has good flexibility. In the FIGS. 3 and 4 variants, the material of the upper part 230, 330 of the body may be more flexible or softer than that of the lower part 228, 328 so as to increase further the flexibility of the body.

The FIG. 5 variant embodiment differs from the FIG. 2 embodiment essentially in that each hook 142′ of the retaining means is connected by a longitudinal web 154′ of material to the upper wall 138′ of the body 114′ disposed directly above it. These webs 154′ are preferably produced at the same time as the rest of the body 114′, for example by extrusion.

The webs 154′ make it possible to delimit two independent cavities 146′ and to isolate them from the rest of the internal space 149′ of the body 114′ and the housing 144′, so that these cavities may be used to circulate a windscreen-washing liquid, for example. In this case, the lateral walls 136′ and/or the lower wall 134′ of the body may include windscreen-washing liquid spray orifices 156′, one end of these orifices 156′ leading into one of the cavities 146′.

The FIG. 6 variant embodiment differs from the FIG. 3 embodiment essentially in that each hook 242′ of the retaining means is connected by a longitudinal web 254′ of material to the upper wall 238′ of the body 214′ disposed directly above it. These webs 254′ are preferably produced at the same time as the rest of the body 214′, for example by extrusion.

The webs 254′ may be made from the material of the upper walls 238′ or that of the hooks 242′. In the example represented, they are made from the material of the upper walls 238′. Here the connecting areas between the two materials are located between the lugs 252′ and the rims 250′ on the one hand and between the webs 254′ and the hooks 242′ on the other hand.

The webs 254′ make it possible to delimit two independent cavities 246′ and to isolate them from the rest of the internal space 249′ of the body 214′ and the housing 244′ so that these cavities may be used to circulate windscreen-washing liquid, for example. In this case, the lateral walls 236′ and/or the lugs 252′ of the body may include windscreen-washing liquid spray orifices 256′, one end of these orifices 256′ leading into one of the cavities 246′.

The FIG. 7 variant embodiment differs from the FIG. 4 embodiment essentially in that each hook 342′ of the retaining means is connected by a longitudinal web 354′ of material to the upper wall 338′ of the body 314′ disposed directly above it. These webs 354′ are preferably produced at the same time as the rest of the body 314′, for example by extrusion.

The webs 354′ may be made from the material of the upper walls 338′ or that of the hooks 342′. In the example represented, they are made from the material of the upper walls 338′. Here the connecting areas between the two materials are located between the lugs 352′ and the rims 350′ on the one hand and between the webs 354′ and the hooks 342′ on the other hand.

The webs 354′ make it possible to delimit two independent cavities 346′ and to isolate them from the rest of the internal space 349′ of the body 314′ and the housing 344′ so that these cavities may be used to circulate windscreen-washing liquid, for example. In this case, the lateral walls 336′ and/or the lugs 352′ of the body may include windscreen-washing liquid spray orifices 356′, one end of these orifices 356′ leading into one of the cavities 346′.

The bodies of the variants in FIGS. 5 to 7 are more rigid than those in FIGS. 2 to 4 because of the webs 154′, 254′, 354′ connecting the upper parts 130′, 230′, 330′ and the lower parts 128′, 228′, 328′ of the body. The position of these webs may be determined to optimize this flexibility. The chain-dotted lines A in FIGS. 5 to 7 show other positions for these webs. The position of these webs also depends on the volume and/or the flow section required for each windscreen-washing liquid circulation cavity. This flow section does not necessarily have a circular shape as shown in the drawing and may have dimensions, of width and of height, between approximately 1 mm and 5 mm, preferably between approximately 2 mm and 4 mm, and more preferably between approximately 2.5 mm and 3.5 mm.

1. A longitudinal body for a wiper of a window of a motor vehicle, said longitudinal body being formed in one piece with means for holding a wiper blade and/or means for retaining a stiffener vertebra, said means defining at least one housing receiving the vertebra or a heel of the wiper blade, said housing being delimited at least in part by a horizontal wall and two vertical walls, said vertical walls being respectively shorter than said horizontal wall seen in cross section, wherein said body defines at least one internal longitudinal cavity that extends out of said housing, said cavity being intersected by a longitudinal plane passing through said vertical walls.

2. The longitudinal body according to claim 1, wherein said at least one longitudinal cavity lies on either side of said means for holding a wiper blade and/or means for retaining a stiffener vertebra.

3. The longitudinal body according to claim 1, wherein said means define a first housing receiving the vertebra and a second housing receiving the heel of the blade, said at least one cavity extending over at least all the height of one of said housings and optionally over at least part of the height of the other of said housings, the height of each housing being measured in a direction substantially perpendicular to said plane.

4. The longitudinal body according to claim 2, wherein said means include at least two longitudinal hooks and said at least one cavity extends at least in part between one of these hooks and a lateral wall of the body.

5. The longitudinal body according to claim 4, wherein each lateral wall of the body is substantially U-, C- or V-shaped in cross section, the open side of which shape is oriented toward an opposite lateral wall of the body.

6. The longitudinal body according to claim 1, wherein the body has a longitudinal plane U of symmetry substantially perpendicular to said plane.

7. The longitudinal body according to claim 1, wherein part of the exterior periphery of the body which borders said at least one cavity forms an aerodynamic deflector.

8. The longitudinal body according to claim 1, this body being made from one or two materials, for example by extrusion or co-extrusion.

9. The longitudinal body according to claim 1, wherein said housing receiving the vertebra communicates with said at least one cavity.

10. The longitudinal body according to claim 1, wherein said at least one cavity is isolated from said housing receiving the vertebra and is configured to be supplied with windscreen-washing liquid.

11. The longitudinal body according to claim 10, including windscreen-washing liquid spray orifices that lead into said at least one cavity.

12. The longitudinal body according to claim 10, wherein said means include hooks for retaining the vertebra, at least one hook for retaining the vertebra, preferably each hook for retaining the vertebra, being connected to an upper wall or a lateral wall of the body by at least one longitudinal web for isolating said at least one cavity.

13. The longitudinal body according to claim 1, wherein said at least one cavity has in cross section a base or lower end wider than its top or upper end.

14. The longitudinal body according to claim 1, having in cross section a shape comprising two parts, respectively an upper part and a lower part, the upper part being substantially triangular and the lower part being substantially trapezoidal or hexagonal.

15. A vehicle window wiper including a longitudinal body according to claim 1, a wiper blade and a stiffener vertebra, said blade or said vertebra being received in said housing.
